(19) United States
(12) Patent Application Publication
(10) Pub. No.: US 2013/0282427 A1
(43) Pub. Date: Oct. 24, 2013

(54) REPUTATION-BASED SERVICE VALUATION

(71) Applicants: Martin Dvorak, Prague (CZ); Juraj Kojdjak, Zilina-Banova SK (SK); Jakub Travnik, Prague (CZ); Noam Fraenkel, Jerusalem (IL)

(72) Inventors: Martin Dvorak, Prague (CZ); Juraj Kojdjak, Zilina-Banova SK (SK); Jakub Travnik, Prague (CZ); Noam Fraenkel, Jerusalem (IL)

(21) Appl. No.: 13/452,598

(22) Filed: Apr. 20, 2012

(51) Int. Cl. G06Q 30/02

(52) U.S. Cl. 705/7.29

(57) ABSTRACT

A system and method for reputation-based service valuation are provided herein. The method includes receiving, within a computing system, subjective evaluation criteria relating to a service from any of a number of users of the service. The method also includes scaling the subjective evaluation criteria based on a reputation of each of the users to produce reputation-based subjective evaluation criteria. The method further includes generating a service valuation for the service based on the reputation-based subjective evaluation criteria.

### BACKGROUND

The introduction of social utilities into the enterprise environment has transformed the manner in which people communicate, share experiences, and exchange information via the Internet. A significant number of organizations aim to leverage such social utilities for a variety of purposes. For example, evaluation criteria gathered from social utilities may be used by an organization for the improvement of service portfolio strategies. Service portfolio strategists may use such evaluation criteria for the identification of service portfolio gaps, as well as the identification of weak services and popular services. As an example, a service portfolio may be a collection of services, or applications, that are offered to employees of a specific company. The service portfolio strategists within the company may use evaluation criteria obtained from the employees to improve the service portfolio.

Evaluation criteria that may be used by service portfolio strategists include objective evaluation criteria and subjective evaluation criteria. According to current techniques, objective evaluation criteria form the essential input for the evaluation of service portfolios. However, objective evaluation criteria describe only the quality, health, and technical performance of a service. Thus, if a service is to be used by people, subjective evaluation criteria can be used to determine a level of service satisfaction relating to the service.

Unfortunately, current systems provide only basic means for gathering such subjective evaluation criteria, and do not provide a means for analyzing the subjective evaluation criteria sufficiently. In addition, such systems can be confused, either by complicated inputs or by deliberate user actions. Therefore, the outputs of such systems may not be reliable enough to be used by service portfolio strategists.

### BRIEF DESCRIPTION OF THE DRAWINGS

Certain examples are described in the following detailed description and in reference to the drawings, in which:

FIG. 1 is a block diagram of a computing system that may be used for the valuation of a service portfolio;

FIG. 2 is a block diagram of a computing environment that may be used for the dissemination of a service portfolio;

FIG. 3 is a block diagram showing the internal components of the valuation application;

FIG. 4 is a block diagram showing types of social data that may be used for the valuation of a service portfolio;

FIG. 5 is a block diagram showing the flow of data for a process for the valuation of services and vendors;

FIG. 6 is a process flow diagram showing a method for reputation-based service valuation; and

FIG. 7 is a block diagram showing a tangible, non-transitory, computer-readable medium that stores a protocol adapted to generate reputation-based service and vendor valuations.

### DETAILED DESCRIPTION OF SPECIFIC EXAMPLES

Service portfolio strategies may be determined by strategists who are responsible for the governance of an organization's service portfolio. Such strategists are referred to herein as “service portfolio strategists.” As used herein, the term “service” refers to any type of software program or application that provides specific functionalities within a computing environment. For example, a service may be an email application on the Web or a mobile phone. In addition, as used herein, the term “service portfolio” refers to a group of services certified for use within a particular organization, which may be optimized by a service portfolio strategist. The term “service catalog” refers to a public marketplace offering services to customers or organizations. Thus, a service catalog may serve as a tool for manipulating service portfolios, since services from the service catalog may be added to various service portfolios.

Each service within a service portfolio or service catalog typically includes a description of the service, timeframes or service-level agreement (SLA) information for fulfilling the service, a list of the individuals who are entitled to request or view the service, a list of the service features, the cost of the service (if any), and the manner in which the service may be fulfilled. In various examples, both cloud and on-premise services are governed by a solution that includes a service portfolio. The service portfolio may allow employees to request subscriptions to particular services or customers to buy the service. In addition, the IT department of the organization may control, analyze and request reports related to the quality, consumption and financials of the services.

Services are typically evaluated using objective evaluation criteria, e.g., the number of incidents, errors, or SLA breaches, among others, that have occurred in conjunction with the service. However, as discussed above, objective evaluation criteria may not be sufficient whenever the service is to be used by people. Therefore, systems and methods described herein relate generally to the use of subjective evaluation criteria, in addition to objective evaluation criteria, for the improvement of service portfolio strategies. Subjective evaluation criteria may include, for example, information relating to the ease of use of a service, the productivity of the user with regard to the service, e.g., the ability of the user to utilize the service efficiently, or the ergonomic capabilities of the service. In addition, such subjective evaluation criteria may be evaluated using a variety of information, such as information relating to which service is the most highly rated, the most used, the most searched, the most accessed, the most reviewed, or the like. Further, because subjective evaluation criteria typically cannot be measured by a machine, systems and methods described herein allow for the gathering of such subjective information from users.

More specifically, systems and methods described herein provide techniques for reputation-based catalog item valuation, e.g., the valuation or rating of a specific item, or service, within a service catalog or a service portfolio. Such techniques may be applied globally or within a particular functional domain. In addition, such techniques may be used for both reputation-based service valuation and reputation-based vendor valuation. The valuation of a service may be based on feedback from a variety of users, wherein the feedback is scaled based, at least in part, on the reputation, or credibility, of each of the users. The dependency of such valuations on the reputations of users may help to filter out low quality information from untrustworthy users, such as users who intend to delude or confuse the system. Further, the valuation of a vendor may be based on the valuations of services that are provided by the particular vendor, rather than ratings and valuations that are provided directly by the vendor. As used herein, the term “vendor” refers to an entity or company that provides, or publishes, specific services to service catalogs.

Service portfolio strategists may use such valuations for a variety of purposes, such as for the identification of service portfolio gaps, or the identification of weak services or popular services. In addition, service valuations and vendor valuations may aid service portfolio strategists in the improvement of the service throughout various stages of the service's lifetime, e.g., inception, audit, validation, functional redundancy elimination, and retirement.

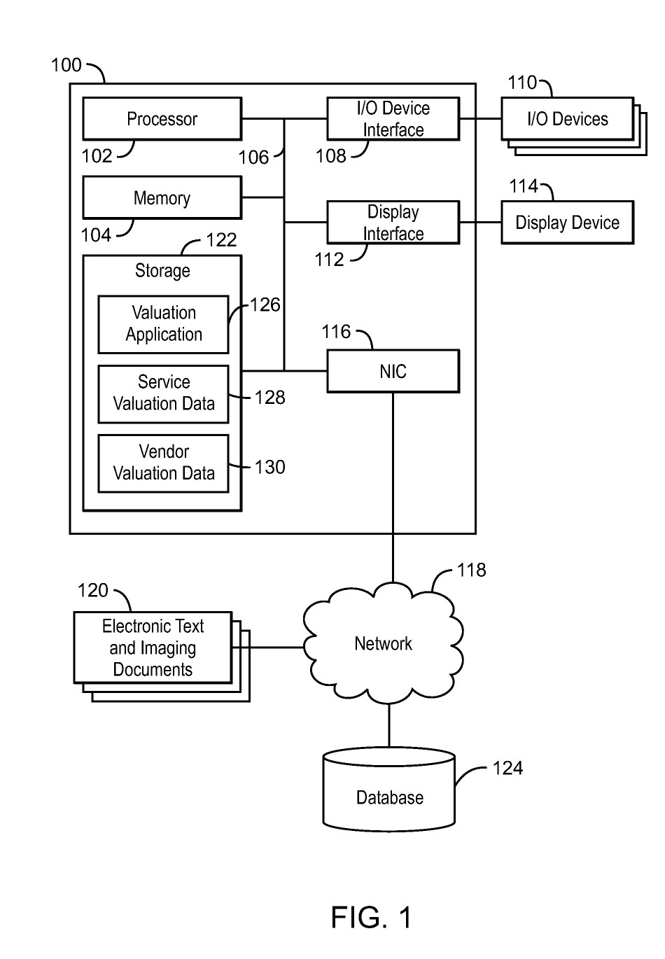

FIG. 1 is a block diagram of a computing system 100 that may be used for the valuation of a service portfolio. The computing system 100 may be, for example, a mobile phone, laptop computer, desktop computer, or tablet computer, among others. The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (RAM), read only memory (ROM), flash memory, or any other suitable memory systems. The instructions that are executed by the processor 102 may be used to implement a method that includes performing reputation-based service valuation and reputation-based vendor valuation.

The processor 102 may be connected through a bus 106 to an input/output (I/O) device interface 108 adapted to connect the computing system 100 to one or more I/O devices 110. The I/O devices 110 may include, for example, a keyboard and a pointing device, wherein the pointing device may include a touchpad or a touchscreen, among others. The I/O devices 110 may be built-in components of the computing system 100, or may be devices that are externally connected to the computing system 100.

The processor 102 may also be linked through the bus 106 to a display interface 112 adapted to connect the computing system 100 to a display device 114. The display device 114 may include a display screen that is a built-in component of the computing system 100. The display device 114 may also include a computer monitor, television, or projector, among others, that is externally connected to the computing system 100.

A network interface card (NIC) 116 may be adapted to connect the computing system 100 through the bus 106 to a network 118. The network 118 may be a wide area network (WAN), local area network (LAN), or the Internet, among others. Through the network 118, the computing system 100 may access electronic text and imaging documents 120. The computing system 100 may also download the electronic text and imaging documents 120 and store the electronic text and imaging documents 120 within a storage device 122 of the computing system 100.

Through the network 118, the computing system 100 may be communicably coupled to a database 124. The database 124 may include any type of computing device that is configured to store social data (not shown). Such social data may include, for example, service reviews and service ratings, as well as information relating to flagging a service as favorite and accessing a service profile.

The storage device 122 can include a hard drive, an optical drive, a thumbdrive, an array of drives, or any combinations thereof. The storage device 122 may include a valuation application 126 that is configured to perform the service valuation and vendor valuation techniques described herein. The valuation application 126 may obtain specific social data from the database 124 via the network 118, and may use the social data for the valuation process.

In addition, the storage device 122 may include service valuation data 128 and vendor valuation data 130 that is created by the valuation application 126. The service valuation data 128 and the vendor valuation data 130 may be used by the user of the computing system 100 to improve the performance of a particular service, or to modify a service portfolio. The user of the computing system 100 may be, for example, a service portfolio strategist.

It is to be understood that the block diagram of FIG. 1 is not intended to indicate that the computing system 100 is to include all of the components shown in FIG. 1. Further, the computing system 100 may include any number of additional components not shown in FIG. 1, depending on the specific application.

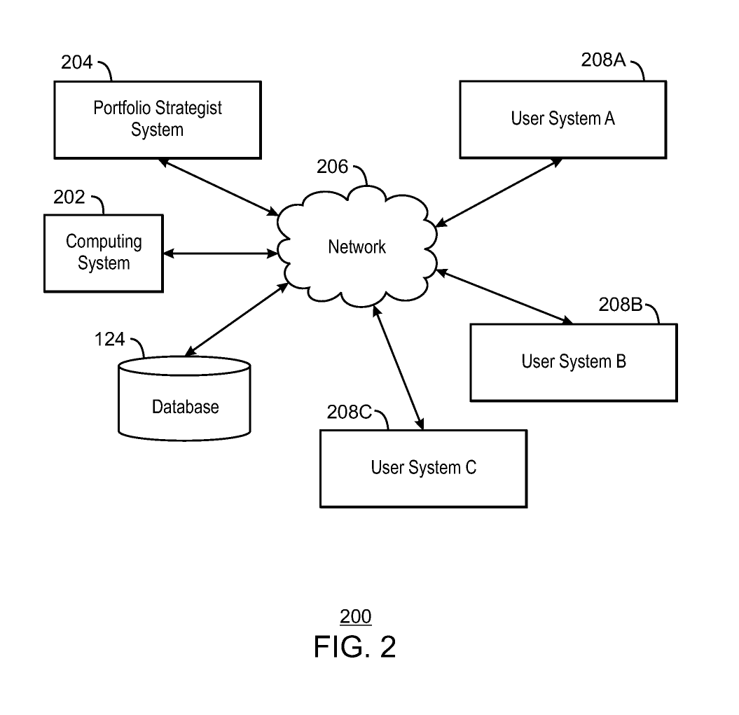

FIG. 2 is a block diagram of a computing environment 200 that may be used for the dissemination of a service portfolio. Like numbered items are as described with respect to FIG. 1. The computing environment 200 may be a cloud computing environment, and the techniques described herein may relate to the improvement of a cloud service portfolio. For example, the computing environment 200 may include a number of cloud servers and databases that run on a cloud computing platform. In addition, the service and vendor valuation procedure described herein may be performed within the cloud computing platform in response to input from a computing system 202. In various embodiments, the computing system 202 is the computing system 100 discussed above with respect to FIG. 1.

The computing environment 200 may include a portfolio strategist system 204. The portfolio strategist system 204 may be communicably coupled to the computing system 202 via a network 206. The network 206 may be a WAN, a LAN, or the Internet, among others. In various examples, a service portfolio strategist may use the portfolio strategist system 204 to control the execution of the service and vendor valuation techniques described herein.

In some examples, the service portfolio strategist is a particular vendor, and the service portfolio may be used to track the valuations of the services provided by the vendor, as well as the valuation of the vendor itself. This information may be used, for example, to improve the quality of particular services and, therefore, increase the popularity of the vendor.

In other examples, the service portfolio strategist is an administrator of a particular company or organization, and the service portfolio may be used to track the valuations of particular services that the company or organization provides to its employees or members. Such valuations may be used, for example, to improve the usefulness of the service portfolio or the quality of particular services in order to increase a productivity of the employees or members of the company or organization.

The computing environment 200 may also include a number of user systems 208, e.g., user system A 208A, user system B 208B, and user system C 208C. The user systems 208 may be lightweight clients within the computing environment 200. Each of the user systems 208 may include a Web browser. The user systems 208 may be configured to execute, or direct the execution of, a particular service for which a service valuation is desired. Thus, subjective evaluation criteria and objective evaluation criteria relating to the particular service may be collected from users via the Web browser of each of the user systems 208.

In some examples, each of the user systems 208 may include a user interface that allows the user to interface with a number of social user interface widgets (not shown). The social user interface widgets are elements of a graphical user interface (GUI) that display an information arrangement that is changeable by the user. The social user interface widgets may allow the user to enter specific subjective evaluation criteria relating to the service, such as, for example, ratings or reviews.

The objective evaluation criteria and the subjective evaluation criteria that are collected from the user systems 208 may be sent to the database 124 via the network 206. The database 124 may include any type of database or computing system that is configured to store the objective evaluation criteria and the subjective evaluation criteria, as discussed with respect to FIG. 1. The database 124 may store the objective evaluation criteria and the subjective evaluation criteria until it is requested by the computing system 202. The computing system 202 may request the objective evaluation criteria and the subjective evaluation criteria in response to input from the portfolio strategist system 204. Once the objective evaluation criteria and the subjective evaluation criteria have been requested by the portfolio strategist system 204, the objective evaluation criteria and the subjective evaluation criteria may be sent to the computing system 202 via the network 206. Further, in some cases, the objective evaluation criteria and the subjective evaluation criteria may be sent directly from the user systems 208 to the computing system 202, depending on the specific application.

As discussed above, the computing system 202 may perform the service and vendor valuation techniques described herein in response to input from the portfolio strategist system 204. More specifically, the computing system 202 may utilize the objective evaluation criteria and the subjective evaluation criteria relating to a service to generate a service valuation. In addition, the computing system 202 may use the service valuations from a number of services that are offered by a particular vendor to generate a vendor valuation. This information may then be used by the portfolio strategist system 204 to produce an updated and improved service portfolio.

The updated and improved service portfolio may then be provided to the user systems 208. The users of the user systems 208 may be allowed to view the information contained in the service portfolio via a valuation visualization module. Then, the users of the user systems 208 may provide additional feedback relating to the service, which may be used to further improve the service portfolio. Thus, the techniques described herein provide for the continuous improvement of a service portfolio as the users' desires and experiences evolve over time.

It is to be understood that the block diagram of FIG. 2 is not intended to indicate that the computing environment 200 is to include all of the components shown in FIG. 2. Further, the computing environment 200 may include any number of additional components not shown in FIG. 2, depending on the specific application.

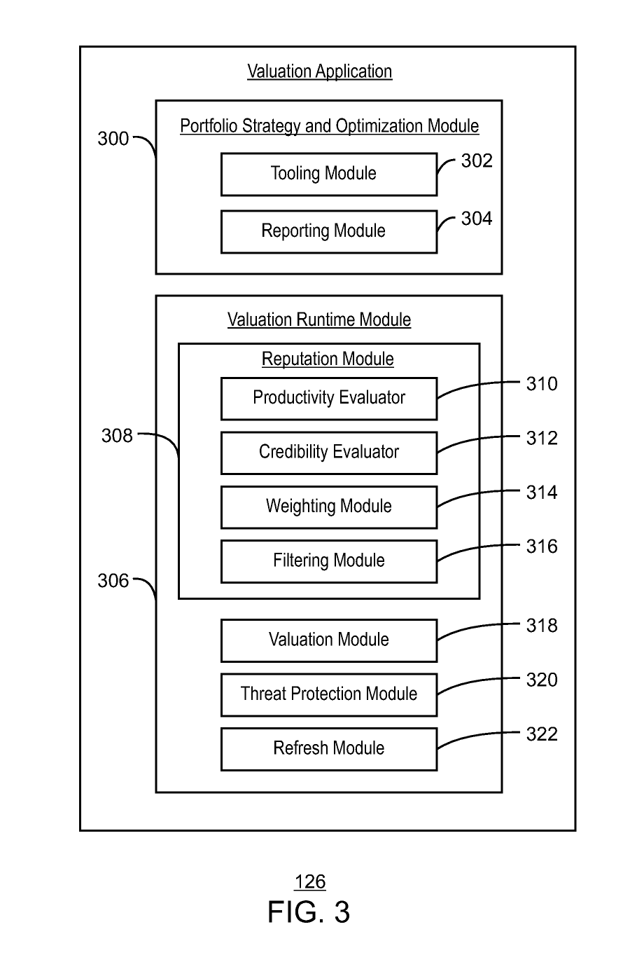

FIG. 3 is a block diagram showing the internal components of the valuation application 126. Like numbered items are as described with respect to FIGS. 1 and 2. The valuation application 126 may be included within the storage device 122 of the computing system 100, as discussed above. In addition, the valuation application 126 may be included within a cloud computing platform. The valuation application 126 may be configured to perform the service and vendor valuation techniques described herein.

The valuation application 126 may include a service portfolio strategy and optimization module 300 that is configured to allow a service portfolio strategist to manage a service portfolio. For example, a tooling module 302 may be configured to allow the service portfolio strategist to edit and improve a service portfolio based, at least in part, on service or vendor valuation information generated by the valuation application 126. In addition, a reporting module 304 may be configured to generate reports that are based on the service and vendor valuations. Such reports may be used by a service portfolio strategist to improve a service portfolio by, for example, eliminating weak services or editing services that are not functioning properly. A subset of these reports may also be presented to the regular users, or service consumers, via the user systems 208.

The valuation application 126 may also include a valuation runtime module 306 that is configured to generate service valuations and vendor valuations based on subjective and objective evaluation criteria relating to particular services. The valuation runtime module 306 may include a reputation module 308 that is configured to determine the reputations of various users. The reputation of a user may be based on a productivity of the user, as determined by a productivity evaluator 310, and a credibility of the user, as determined by a credibility evaluator 312. In various examples, the reputation of user is defined as the user's productivity weighted by the user's credibility among other users.

The valuation application 126 may group users into organizations. The grouping of users into organizations corresponds to real life companies and employees. In some cases, organization administrators may be allowed to decide whether users' social data, e.g., reputation, reviews, or ratings, will be shared with other organizations.

The valuation application 126 may also assign different roles to different users. For example, moderators and administrators may be considered to be privileged users. In addition, service portfolio strategists may be considered to be privileged users from a portfolio optimization perspective. In contrast, consumers of the service may be considered to be regular, or unprivileged, users. Privileged users may be given additional capabilities as compared to regular users. For example, privileged users may be assigned a higher credibility and, thus, a better reputation. This may cause the social data that is collected from privileged users to have a greater effect on the service and vendor valuations. In contrast, while regular users may be allowed to write reviews about a service or rate the service, the effect of such input from a regular user may have little effect on the service or vendor valuations, depending on the user's overall reputation.

According to the techniques described herein, the reputation of a user is determined indirectly based on the user's actions and the output of other users' actions. For example, a user's actions, e.g., writing a review or rating a service, may be tracked, and the quality of the user's actions may be used for the user's reputation assessment. The quality of the user's actions may be determined based on input from other users.

The reputation of a user may be based on a point system. For specific actions performed by the user, such as writing a review, flagging a review as helpful, rating a service, marking a service as favorite, accessing a service profile, finding a service, or getting approved service certification suggestions, the user is awarded a certain number of points. The number of points that are awarded for each type of action may vary. In addition, the range of possible point values may vary, depending on the specific application.

In addition, the reputation of a user may be a function of time. The latest contributions to the user's reputation may be weighted more heavily than contributions from the past. In other words, points and actions that are used in a user's credibility calculation may not be assigned once and last forever. On the contrary, points and actions may be saved, and the effect of the particular points and actions on the user's reputation may depend on when the reputation is calculated. In addition, the time frame that is taken into consideration may be configurable.

In some examples, the contribution of a particular action of a user to the user's reputation may be weighted according to time using the formula shown in Eq.

$${coefficient}_{time} = {f}_{time factor} ( max ( 0 , \frac{{time}_{period} - {time}_{elapsed}}{{time}_{period}} ) ) \qquad Eq . 1$$

As used in Eq. 1, time_{elapsed} is equal to the time that elapsed from when the action occurred, and time_{period} is equal to the period of time after which the weight of the event is to be lowered, which may be configurable for each particular action type. In addition, a value c may be defined as a configurable minimal value of coefficientₜᵢₘₑ that is used in the default f_{time factor}. The value of c may be any value between 0 and 1. The value of f_{time factor} may be determined using the formula shown in Eq. 2.

f_{time factor}(x)=x*(1−C)+c Eq. 2

As used in Eqs. 1 and 2, f_{time factor} is a configurable function that can change how the weight of an action declines over time. Further, according to Eqs. 1 and 2, coefficientₜᵢₘₑ may be any value between c and 1. The value of coefficientₜᵢₘₑ may be used to determine the actual number of points that are assigned to an event as a function of time using the formula shown in Eq. 3.

point_{actual value}=point_{original value}*coefficientₜᵢₘₑ Eq. 3

Further, the reputation module 308 may be extensible. For example, new criteria may be added to the credibility formula that is used by the credibility evaluator 312. In addition, new actions may be added to the list of actions that are considered by the productivity evaluator 310.

The reputations of various users may be used to scale, e.g., weight and filter, the social feedback that is collected from the users. Such weighting and filtering may be performed by a weighting module 314 and a filtering module 316, respectively.

The valuation runtime module 306 may also include a valuation module 318 that is configured to generate a service valuation based on the social data, e.g., the subjective evaluation criteria, that has been collected from the users. The social data that is used by the valuation module 318 may be the social data that has been weighted and filtered according to users' reputations. Once the service valuation has been generated, a vendor valuation may also be generated based on the service valuation, as well as the valuations of other services that are provided by the vendor.

In various examples, the service valuation is defined by an expression that is based on a reputation-based rating, favorites index, access frequency, and search frequency of a service. In addition, a vendor valuation may be defined as a median of the vendor's service valuations.

The valuation runtime module 306 may include a threat protection module 320 that is configured to protect the service and vendor valuation process from being corrupted or deluded by users with bad intentions. The threat protection module 302 may provide protection mechanisms that prevent the corruption of the service and vendor valuation process at every level. For example, such protection mechanisms may protect the service and vendor valuation process from spoofing, collusion and friend emphasizing.

According to examples described herein, a basic level of protection is provided by the fact that the user is never rated directly. On the contrary, the user's reputation is based on the output of other users' actions. Protection is also applied on the level of user actions by controlling the actual contribution of such actions to the service or vendor valuation. This is accomplished by allowing only actions that are performed by a particular set of users or in a certain period of time, for example, to contribute to the service or vendor valuation.

The threat protection module 320 may provide productivity protection by enforcing limits on particular indicators. For example, the threat protection module 320 may impose a daily limit on number of accesses, ratings, reviews, and searches that are accepted from a particular user. This may ensure balanced productivity growth by imposing limits on daily increases in a user's productivity. In addition, per indicator thresholds may be used to ensure that particular indicators do not contribute to a user's productivity more than desired.

The threat protection module 320 may also provide credibility protection by ensuring that users are never rated directly, as discussed above. The threat protection module 320 may provide for the distribution of credibility contributors. In other words, a user's actions may be evaluated by a potentially high number of other users that have different roles, such as the user or service portfolio strategist. In addition, certain indicators that contribute to the credibility may depend on the opinion of the majority as determined by polls, which is difficult to influence. Credibility protection may also provide reputation protection by ensuring that high user productivity without reasonable user credibility has minimal impact on the user's overall reputation.

Further, the threat protection module 320 protects service valuations by using reputation-weighted service related feedback, such as ratings and favorites, and limiting protected popularity feedback, such as the number of accesses or search hits. Vendor valuations are based solely on the values of the service valuations for particular vendors. Thus, the protection of service valuations also provides protection of vendor valuations. In addition, a function may be used to prevent an extreme, i.e., very high or very low, valuation of a single service from having a large impact on a vendor valuation.

The valuation runtime module 306 may also include a refresh module 322. The refresh module 322 may be configured to periodically refresh the valuation application 126. This may be performed in order to ensure that the valuation application 126 is using the most recent social data to generate the service and vendor valuations.

It is to be understood that the block diagram of FIG. 3 is not intended to indicate that the valuation application 126 is to include all of the components shown in FIG. 3. Further, the valuation application 126 may include any number of additional components not shown in FIG. 3, depending on the specific application.

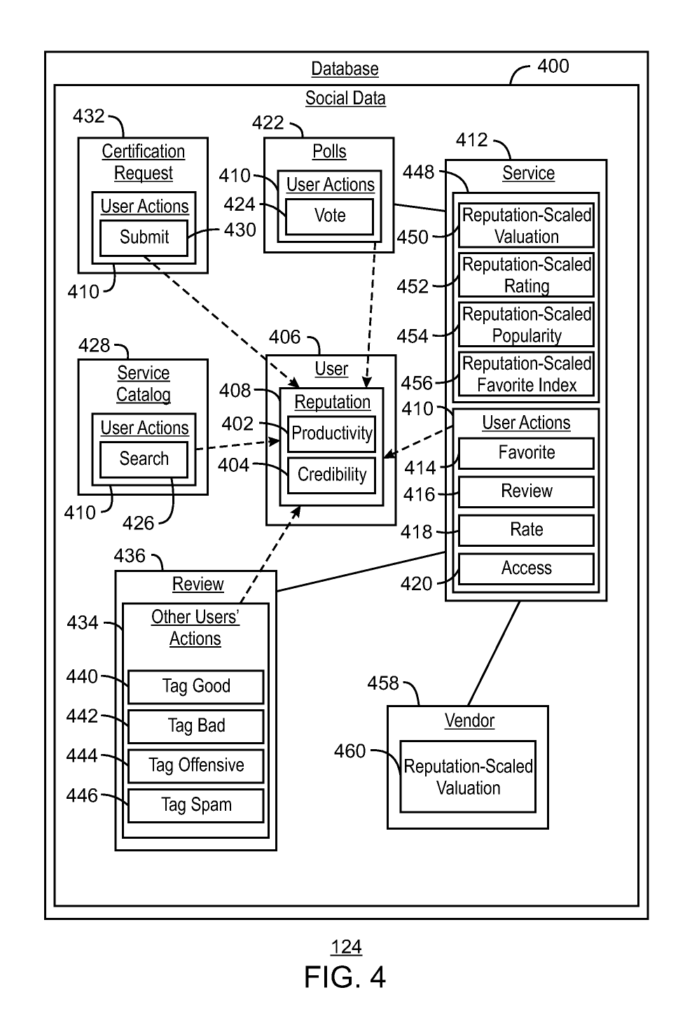

FIG. 4 is a block diagram showing types of social data 400 that may be used for the valuation of a service portfolio. The social data 400 may include subjective evaluation criteria relating to a particular service. In addition, the social data 400 may be related to specific actions by users, as discussed further below. The social data 400 may be stored within the database 124, as shown in FIG. 4.

The social data 400 may be used to determine a productivity 402 and a credibility 404 of a particular user 406. The productivity 402 and the credibility 404 may then be used to determine a reputation 408 of the user 406. Such determinations may be made based on the actions of the user 406, as well as feedback from other users about the actions of the user 406.

The productivity 402 of the user 406 may be determined based on user actions 410 in relation to services, such as a particular service 412. The user actions 410 may include providing input regarding a number of different subjective evaluation criteria, such as designating a favorite, e.g., “favorite” 414, writing a review, e.g., “review” 416, providing a rating, e.g., “rate” 418, or attempting to access the service 412, e.g., “access” 420.

The productivity 402 of the user 406 may also be impacted by a number of different user actions 410. For example, if the user 406 participates in polls 422 by voting, e.g., “vote” 424, for particular services, the productivity 402 of the user 406 may be positively affected. For example, a service portfolio strategist may request a community poll in order to obtain feedback regarding the popularity of a service. The user's participation in a particular poll 422 may automatically increase the productivity 402 of the user 406. However, the credibility 404 of the user 406 may be positively or negatively affected, depending on the percentage of the total number of polls 422 in which the user 406 voted with the majority.

If the user 406 accesses or searches, e.g., “search” 426, a service catalog 428, the productivity 402 of the user 406 may be increased. This productivity 402 of the user 406 may be increased because the user 406 is more likely to be a reliable source if the user 406 has performed some sort of research regarding services within the service catalog 428.

Further, the productivity of the user 406 may be increased if the user 406 submits, e.g., “submit” 430, a certification request 432 to the service portfolio strategist. The certification request 432 may contribute to the service portfolio creation process by suggesting services for certification to the service portfolio strategist.

The reputation 408 of the user 406 may also be affected by other users' actions 434. For example, other users may participate in a review 436 of the user actions 410. The review 436 may be submitted by any user who is, or was, a subscriber to the service 412. The review 436 may include tagging the user actions 410 as good or helpful, e.g., “tagGood” 440, tagging the user actions 410 as bad, e.g., “tagBad” 442, tagging the user actions 410 as offensive, e.g., “tagOffensive” 444, or tagging the user actions 410 as spam, e.g., “tagSpam” 446. The reputation 408 or, more specifically, the credibility 404 of the user 406 may then be adjusted by varying numbers of positive or negative points depending on the other users' actions 434. For example, the user 406 may be assigned a high number of points if the other users' actions 434 assign a best rating to the user actions 410. In addition, the effect of the other users' actions 434 may be scaled based on a reputation of each of the other users that submits the review 436. For example, in some examples, only users with the highest reputations, e.g., in the top 10%, are allowed to tag the user actions 410 as offensive or as spam, while only the moderator is allowed to delete any of the user actions 410.

In various examples, the credibility 404 of the user 406 at a specific time, t, is determined as shown in Eq. 4.

$${Credibility}_{user}^{t} = average ( Σ \frac{{review}_{given with > 50 \% good flags}^{t}}{count ( {review}_{given}^{t} )} , Σ \frac{{poll}_{given with majority}^{t}}{count ( {poll}_{given}^{t} )} , Σ \frac{{certification}_{suggested and approved}^{t}}{count ( {certification}_{suggested}^{t} )} ) , ∈ [ 0 , 1 ] \qquad Eq . 4$$

The productivity 402 of the user 406 at the specific time may be determined as shown in Eq. 5.

Productivityᵤₛₑᵣ^{t}=Σreview_{written}^{t}+Σpolls_{made}^{t}+Σreview_{good flags given}^{t}+Σreview_{bad flags given}^{t}+Σratings_{given}^{t}+Σcertification_{suggested}^{t}+Σfavorites_{given}^{t}+Σlogins^{t},ε[0,+∞) Eq. 5

The reputation 408 of the user 406 at the specific time may then be determined based on the credibility 404 and the productivity 402, as shown below in Eq. 6.

Reputationᵤₛₑᵣ^{t}=Credibilityᵤₛₑᵣ^{t}*Productivityᵤₛₑᵣ^{t},ε+∞) Eq. 6

In some examples, a user's social data is not used for reputation calculations until the user has written a review, voted in a poll, submitted a certification suggestion, or performed some other action that is pertinent to the reputation calculation. Thus, the user's reputation may be unknown until the user participates in the system. In addition, the user's multiplier may be equal to 0 if the user has a negative balance of points received for his actions rated by feedback from other users. This prevents the ratings of users with bad reputations from having an impact on service ratings and valuations.

The formula for calculating the reputation, i.e., Eq. 6, is extensible. In other words, new criteria may be added to the credibility formula, i.e., Eq. 4, or the productivity formula, i.e., Eq. 5, depending on the specific application.

The actions 410 of the user 406, as well as the actions of various other users, with relation to the service 412 may be used to produce a number of evaluation outputs 448 regarding the service 412. The evaluation outputs 448 may be scaled, or weighted and filtered, according to the reputation 408 of the user 406, as well as the reputations of the other users. The evaluation outputs 448 may include a reputation-based valuation 450 of the service 412, a reputation-based rating 452 of the service 412, a reputation-based popularity 454 of the service 412, and a reputation-based favorite index 456 of the service 412. In addition, the service valuation 450 for the service 412, as well as service valuations for other services provided by a same vendor 458, may be used to produce a reputation-based valuation 460 of the vendor 458.

The reputation-based rating 452 of the service 412 may be calculated as shown in Eq. 7, in which the rating_{by user i} belongs to the interval [0,1].

Rating_{service}^{t}=(Σ(rating_{by user i}*reputation_{user i}^{t})/Σreputation_{user i}^{t}) Eq. 7

The reputation-based popularity 454 of the service 412 may be calculated as shown in Eq. 8.

Favorite_{service}^{t}=Σ(favorite_{by user i}*reputation_{user i}^{t})/Σreputation_{user i}^{t} Eq. 8

The reputation-based favorite index 456 of the service 412 may be calculated as shown in Eq. 9.

Popularity_{service}^{t}=(Σaccess_{service}^{t}/Σaccess_{all service}^{t}+Σsearchₕᵢₜₛ^{t}/Σsearch_{all hits}^{t})/2 Eq. 9

The reputation-based rating 452, the reputation-based popularity 454, and the reputation-based favorite index 456 of the service 412 may be calculated for ε[0,1].

The reputation-based valuation 450 of the service 412 may then be calculated based on the reputation-based rating 452, the reputation-based popularity 454, and the reputation-based favorite index 456, as shown below in Eq. 10.

Valuation_{service}^{t}=c₁*Rating_{service}^{t}+c₂*Favorite_{service}^{t}+c₃*Popularity_{service}^{t},ε[0,Σ(cᵢ)] Eq. 10

The value of the criteria cᵢ may be configurable. However, by default, cᵢ=1, e.g., all criteria have the same weight.

The reputation-based valuation 460 of the vendor 458 may be calculated using the reputation-based valuation 450 of the service 412, as well the reputation-based valuation of other services provided by the vendor 458, as shown in Eq. 11.

Valuation_{vendor}^{t}=median(Valuation_{service}^{t}),ε[0+∞) Eq. 11

The number of service subscribers may not be used as a parameter contributing to the reputation-based valuation 450 of the service 412. This is due to the fact that the number of service subscribers represents subjective evaluation criteria that may not relate to the popularity of the service 412, since subscription to the service 412 may be mandatory in some cases.

The reputation-based valuation 450 of the service 412 and the reputation-based valuation 460 of the vendor 458 may be further scaled depending on the specific application. For example, if the valuation 450 or 460 is to be determined within the scope of one organization, all the evaluation criteria may be taken from that organization. If the valuation 450 or 460 is to be determined within the public scope, the evaluation criteria may be taken from all organizations within the system. If the valuation 450 or 460 is to be determined within the scope of all organizations other than one specific organization, the evaluation criteria may be taken from all organizations within the system except the one specific organization.

As discussed above with respect to FIG. 3, a reporting module 304 may be configured to generate reports that are based on the reputation-based valuation 450 of the service 412 and the reputation-based valuation 460 of the vendor 458. Such reports may be grouped according to the entity to which the reports pertain, including users, services, or vendors. For users, the reports may include information relating to the user with the best reputation, the user with the worst reputation, and the most active user in terms of reviews, ratings, favorites, or accesses, among others. For services, the reports may include information relating to the best rated service, the most favorite service, the most reviewed service, the most accessed service, the most searched service, or the service with the most search result hits, among others. For vendors, the reports may include information relating to the best rated vendor, the most favorite vendor, the most reviewed vendor, the most accessed vendor, the most searched vendor, or the vendor with the most search result hits. The vendor reports may be based on aggregated average values across multiple vendors' services.

According to FIG. 4, the social data 400 is represented as data that is stored within the database 124. However, any amount of the social data 400 may not be stored within the database 124 but, rather, may be stored directly within the computing system 202 discussed with respect to FIG. 2. Further, the database 124 may only include the basic social data and metadata relating to the service 412, as well as the actions of users. Such basic social data and metadata may then be manipulated by the valuation application 126 to obtain the social data 400.

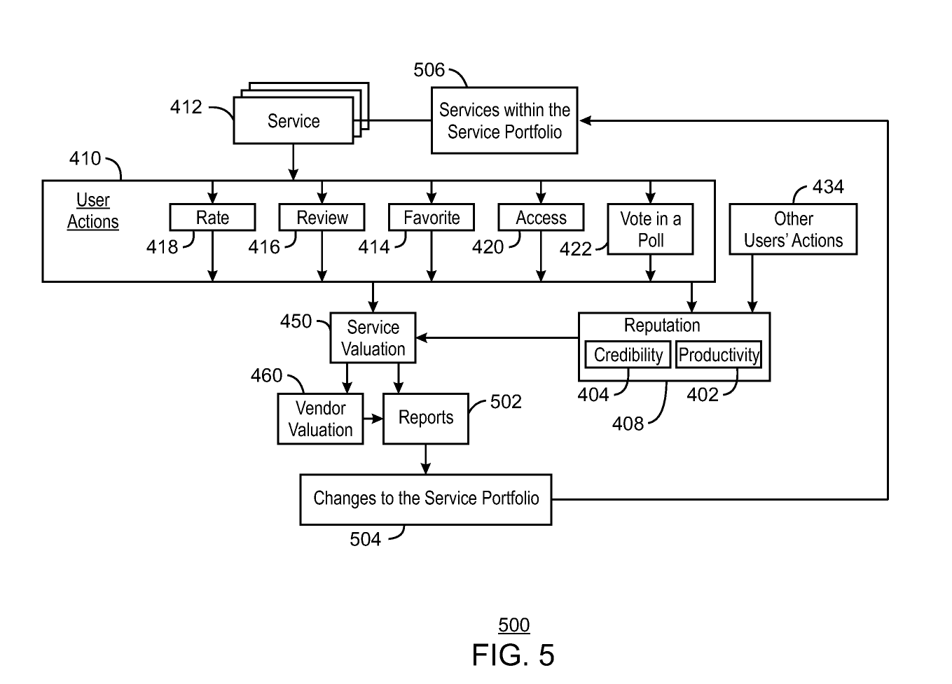

FIG. 5 is a block diagram showing the flow of data 500 for a process for the valuation of services and vendors. Like numbered items are as described with respect to FIG. 4. The process may be used to produce the service valuation 450 of the service 412, as well as the vendor valuation 460 of the vendor 458.

The process may begin with the gathering of data relating to the user actions 410. The user actions 410 may include participating in ratings 418, writing reviews 416, participating in polls 422, choosing favorites 414, or performing actions relating to access 420, as discussed above with respect to FIG. 4.

The output of the user actions 410, as well as the output of other users' actions 434, may be used to perform calculations 502 of the productivity 402 and the credibility 404 of the user 406. The productivity 402 and the credibility 404 may then be used to determine the reputation 408 of the user 406. The reputation 408 of the user 406 may also be determined based on data collected from other users' actions 434.

The output of the user actions 410 and the reputation 408 of the user 406 may be used to perform a calculation of the service valuation 450. In other words, the subjective evaluation criteria obtained from the user 406 may be scaled, e.g., weighted and filtered, to obtain the reputation-based valuation 450 of the service 412. In addition, reputation-based subjective evaluation criteria obtained from other users may also be used to perform the calculation of the service valuation 450. Further, the reputation-based valuation 450 of the service 412, as well as reputation-based valuations for a number of other services provided by the vendor 458, may be used to produce the reputation-based valuation 460 of the vendor 458.

Reports 502 may be generated based on the service valuation 450 or the vendor valuation 460, or both. The reports 502 may be used by a service portfolio strategist to determine improvements to the service portfolio, or improvements to the service 412 itself. Such improvements may be implemented within the service 412 in response to changes 502 to the service portfolio that are made in response to feedback from the service portfolio strategist. Such changes 504 may involve modifications to particular services 506 within the service portfolio.

It is to be understood that the block diagram of FIG. 5 is not intended to indicate that the process for the valuation of services and vendors is to include all of the data 500 discussed with respect to FIG. 5. The process may include any additional data 500 not shown in FIG. 5, depending on the specific application. Further, the flow of the data 500 for the process may differ from the flow described with respect to FIG. 5.

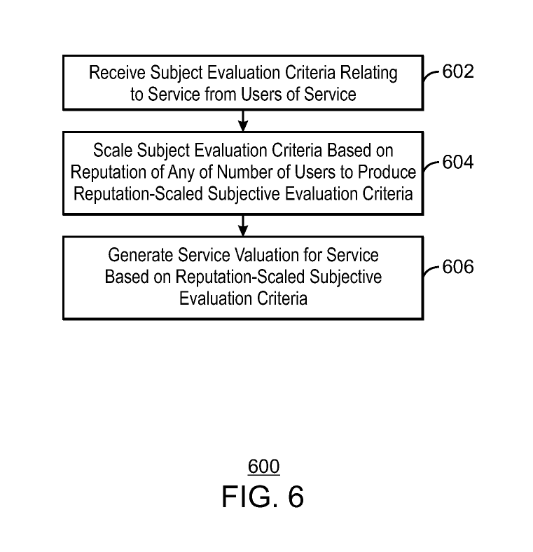

FIG. 6 is a process flow diagram showing a method 600 for reputation-based service valuation. The method 600 may be used to generate service valuations for use by a service portfolio strategist. For example, the service valuations may be used to improve a service portfolio.

The method 600 may be implemented using a computing system, such as the computing system 202 described with respect to FIG. 2. The method 600 may be implemented in response to input from the portfolio strategist system 204 within the computing environment 200, as discussed with respect to FIG. 2. Further, the valuation application 126 described with respect to FIGS. 1 and 3 may be used to perform the steps of the method 600.

The method begins at block 602, at which subjective evaluation criteria relating to a particular service is received from any of a number of users of the service. The subjective evaluation criteria may include data relating to specific actions by the user with relation to the service, such as ratings, reviews, polls, favorites, or accesses, among others.

At block 604, the subjective evaluation criteria are scaled based on a reputation of each of the users to produce reputation-based subjective evaluation criteria. The reputation of a user may be determined based on a credibility and a productivity of the user. The credibility of the user is based on feedback from other users regarding actions of the user, wherein the impact of the feedback from the other users is scaled based on the reputations of each of the other users. The productivity of the user may be determined based on actions of the user.

Scaling the subjective evaluation criteria may include performing a weighting procedure and a filtering procedure. The weighting procedure may include assigning a number of points to the subjective evaluation criteria based on the reputation of each of the users. The filtering procedure may include, for example, discarding or reducing the impact of subjective evaluation criteria from users with bad reputations.

At block 606, a service valuation for the service is generated based on the reputation-based subjective evaluation criteria. The service valuation may be a reputation-based service valuation that accounts for the reputations of users. Users with good reputations may have a greater impact on the service valuation than users with bad reputations. This may be accomplished using a points system. For example, reputation-based subjective evaluation criteria obtained from a user with a good reputation may have a higher point value than reputation-based subjective evaluation criteria obtained from a user with a bad reputation. Thus, the reputation-based subjective evaluation criteria obtained from the user with the good reputation may have a greater impact on the service valuation. Further, in some cases, objective evaluation criteria relating to the service are also used to generate the service valuation.

The process flow diagram of FIG. 6 is not intended to indicate that the steps of the method 600 are to be executed in any particular order, or that all of the steps of the method 600 are to be included in every case. Further, any number of additional steps may be included within the method 600, depending on the specific application. For example, the method 600 may include generating service valuations for each of a number of services provided by a particular vendor, and generating a vendor valuation for the vendor based on the service valuations.

In addition, the method 600 may include generating one or more reports based on the service valuation or the vendor valuation, or both. Such reports may be provided to a service portfolio strategist, or to any administrator of the method 600. The service portfolio strategist may use the reports to determine possible improvements to the service portfolio relating to the service, as well as possible improvements to the service itself. Thus, the method 600 may also include adjusting the service portfolio, or the service itself, in response to input from the service portfolio strategist.

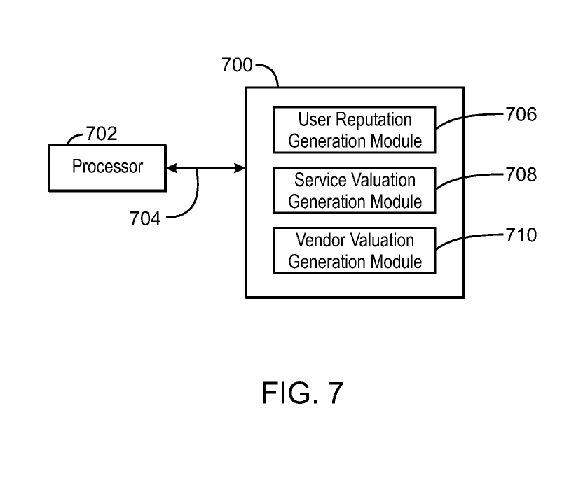

FIG. 7 is a block diagram showing a tangible, non-transitory, computer-readable medium 700 that stores a protocol adapted to generate reputation-based service and vendor valuations. The tangible, non-transitory, computer-readable medium 700 may be accessed by a processor 702 over a computer bus 704. Furthermore, the tangible, non-transitory, computer-readable medium 700 may include code to direct the processor 702 to perform the steps of the current method.

The various software components discussed herein may be stored on the tangible, non-transitory, computer-readable medium 700, as indicated in FIG. 7. For example, a user reputation generation module 706 may be configured to direct the processor 702 to calculate a reputation of a user based on the credibility and the productivity of the user. A service valuation generation module 708 may be configured to direct the processor 702 to generate a reputation-based service valuation using reputation-based subjective evaluation criteria from a number of users. A vendor valuation generation module 710 may be configured to direct the processor 702 to generate a reputation-based vendor valuation for a particular vendor using reputation-based service valuations for services provided by the vendor.

It is to be understood that FIG. 7 is not intended to indicate that all of the software components discussed above are to be included within the tangible, non-transitory, computer-readable medium 700 in every case. Further, any number of additional software components not shown in FIG. 7 may be included within the tangible, non-transitory, computer-readable medium 700, depending on the specific application.

The present techniques may be susceptible to various modifications and alternative forms and have been shown only by way of example. It is to be understood that the technique is not intended to be limited to the particular examples disclosed herein. Indeed, the present techniques include all alternatives, modifications, and equivalents falling within the true spirit and scope of the appended claims.

1. A method for reputation-based service valuation, comprising:
receiving, at a computing system, subjective evaluation criteria and objective evaluation criteria relating to a service from a database, wherein the subject evaluation criteria comprise social data collected from a plurality of users of the service;
scaling, via a processor of the computing system, the subjective evaluation criteria based on a reputation of each of the plurality of users to produce reputation-based subjective evaluation criteria;
generating a service valuation for the service based on the reputation-based subjective evaluation criteria and the objective evaluation criteria;
generating a report relating to the service based on the service valuation; and
displaying the report via a display device of the computing system.

2. The method of claim 1, comprising:
generating service valuations for each of a plurality of services offered by a vendor; and
generating a vendor valuation for the vendor based on the service valuations.

3. The method of claim 1, wherein scaling the subjective evaluation criteria comprises weighting the subjective evaluation criteria by assigning a number of points to the subjective evaluation criteria based on the reputation of each of the plurality of users.

4. (canceled)

5. The method of claim 1, wherein the reputation of a user is determined indirectly based on a credibility and a productivity of the user.

6. The method of claim 5, wherein the credibility of the user is determined based on input relating to the user that is received from other users.

7. The method of claim 5, wherein the productivity of the user is determined based on actions by the user.

8. The method of claim 1, comprising adjusting a service portfolio relating to the service valuation in response to input from a service portfolio strategist.

9. A system for reputation-based service valuation, comprising:
a processor that is adapted to execute stored instructions; and
a storage device that stores instructions, the storage device comprising processor executable code that, when executed by the processor, is adapted to:
receive subjective evaluation criteria and objective evaluation criteria relating to a service from a database, wherein the subject evaluation criteria comprise social data collected from a plurality of users of the service;
weight and filter the subjective evaluation criteria based on a reputation of each of the plurality of users to obtain reputation-based subjective evaluation criteria, wherein the reputation of each of the plurality of users is determined based on a credibility and a productivity of each of the plurality of users; and
generate a service valuation for the service based on the reputation-based subjective evaluation criteria and the objective evaluation criteria.

10. The system of claim 9, wherein the processor executable code is adapted to:
generate a report based on the service valuation;
provide the report to a service portfolio strategist; and
adjust a service portfolio relating to the service in response to input from the service portfolio strategist.

11. The system of claim 9, wherein the processor executable code is adapted to generate a vendor valuation for a vendor that provides the service based on the service valuation and service valuations for other services provided by the vendor.

12. The system of claim 11, wherein the processor executable code is adapted to:
generate a report based on the vendor valuation;
provide the report to a service portfolio strategist; and
adjust a service portfolio relating to service valuations for services provided by the vendor in response to input from the service portfolio strategist.

13. The system of claim 9, wherein the subjective evaluation criteria comprise data relating to ratings, reviews, polls, favorites, or accesses, or any combinations thereof.

14. The system of claim 9, wherein the processor executable code comprises a valuation application.

15. A tangible, non-transitory, computer-readable medium comprising code configured to direct a processor to:
receive subjective evaluation criteria and objective evaluation criteria relating to a service from a database, wherein the subject evaluation criteria comprise social data collected from a plurality of users of the service;
scale the subjective evaluation criteria based on a reputation of each of the plurality of users to produce reputation-based subjective evaluation criteria;
generate a service valuation for the service based on the reputation-based subjective evaluation criteria and the objective evaluation criteria; and
generate a vendor valuation for a vendor that provides the service based on the service valuation and service valuations for a plurality of other services provided by the vendor.

16. The tangible, non-transitory, computer-readable medium of claim 15, wherein the code is configured to direct the processor to:
generate a report based on the service valuation or the vendor valuation, or both; and
provide the report to a service portfolio strategist.

17. The tangible, non-transitory, computer-readable medium of claim 15, wherein the code is configured to direct the processor to calculate the reputation of the user based on a credibility and a productivity of the user.

18. The tangible, non-transitory, computer-readable medium of claim 17, wherein the code is configured to direct the processor to determine the credibility of the user based on feedback from other users regarding actions of the user.

19. The tangible, non-transitory, computer-readable medium of claim 18, wherein the code is configured to direct the processor to weight an impact of the feedback from another user based on a reputation of the other user.

20. The tangible, non-transitory, computer-readable medium of claim 17, wherein the code is configured to direct the processor to determine the productivity of the user based on actions of the user.
